(19) United States
(12) Patent Application Publication
(10) Pub. No.: US 2026/0092483 A1
(43) Pub. Date: Apr. 2, 2026

(54) HINGE FOR A DOOR OF AN AIRCRAFT, WITH PASSAGE FOR A CABLE

(71) Applicant: Airbus Operations (S.A.S.), Toulouse (FR)

(72) Inventor: Benjamin Boisnier, Toulouse (FR)

(21) Appl. No.: 19/337,982

(22) Filed: Sep. 24, 2025

(30) Foreign Application Priority Data
Sep. 27, 2024 (FR) FR2410359

(51) Int. Cl. E05D 11/00; B64C 1/14; E05D 1/04; E05D 1/06; H02B 1/38

(52) U.S. Cl. CPC E05D 11/0081; B64C 1/1461; E05D 1/04; E05D 1/06; B64C 1/1446; E05Y 2900/21; E05Y 2900/502; H02B 1/38

(57) ABSTRACT

A hinge to open or to close a door, for example a door of an electrical cabinet of an aircraft, including at least one first wall and one second wall defining an angular opening of the hinge and a hollow internal space of the hinge sized to receive a cable. The first wall and the second wall are positioned relative to one another in order to open the hinge in a cable insertion or extraction position to allow the cable to pass through the angular opening of the hinge inside or outside the internal space, and to close the hinge in working positions of the hinge between a maximum open position of the door and a closed position of the door to block the angular opening of the hinge so as to be able to enclose the cable in the hollow space.

### TECHNICAL FIELD

The disclosure herein relates to a hinge for a door, for example for an electrical cabinet of an aircraft.

### BACKGROUND

An aircraft generally includes a multitude of electrical cables that must be placed judiciously, both to clutter the aircraft as little as possible and to prevent damage to the cables. In particular, it is difficult to position the cables correctly on passing through a door, for example the door of an electrical cabinet, of the aircraft.

The object of the disclosure herein is to remedy this drawback at least in part.

### SUMMARY

To this end, there is proposed a hinge intended to open or to close a door, for example a door of an electrical cabinet of an aircraft, including at least one first wall and one second wall defining an angular opening in the hinge and a hollow internal space of the hinge sized to receive a cable, the first wall and the second wall being positioned relative to one another in order:
to open the hinge in a cable insertion or extraction position to allow the cable to pass through the angular opening of the hinge inside or outside the internal space, and
to close the hinge in working positions of the hinge, for example between a maximum open position of the door and a closed position of the door, to block the angular opening of the hinge so as to be able to enclose the cable in the hollow space.

Thanks to the hinge according to the disclosure herein it is possible to position the cable in the hinge, on the axis thereof, which simplifies the electrical wiring of the aircraft and in particular that of an electrical cabinet, reduces the clutter due to the cables, and provides improved protection of the cables. Over and above this, the hinge can be fitted without cutting the cable or the cable can be changed without dismantling the hinge.

In accordance with another aspect of the disclosure herein, each first wall and each second wall respectively extends between two ends spaced apart from one another to form an angular opening and defines a hollow internal space, the hinge being shaped so that in the cable insertion or extraction position the angular opening of the first wall and the angular opening of the second wall are aligned, in the working positions of the door the angular opening of the first wall is offset from the angular opening of the second wall to close the hinge, the first and second walls being aligned to define an axis of the hinge.

In accordance with another aspect of the disclosure herein, the hinge includes a part called the mobile part intended to be fixed to the door of the cabinet and a part called the immobile part intended to be fixed to a box of the cabinet, the mobile part including at least one hinge part forming the first wall of the hinge and the immobile part including at least one hinge part forming the second wall of the hinge.

In accordance with another aspect of the disclosure herein, one of the mobile part and the immobile part includes one more hinge part than the other of the mobile part and the immobile part.

In accordance with another aspect of the disclosure herein, one of the mobile part and the immobile part includes at least two hinge parts spaced apart from one another so as to guide at least one hinge part of the other of the mobile part and immobile part.

In accordance with another aspect of the disclosure herein, the hinge includes a locking device conformed to immobilize the hinge in the closed position.

The disclosure herein also has as an object an electrical cabinet including a hinge as described above.

The disclosure herein also has as an object an aircraft including an electrical cabinet as described above.

The disclosure herein also has as an object an aircraft hatch including a hinge as described above.

### BRIEF DESCRIPTION OF THE DRAWINGS

Other features, details and advantages of the disclosure herein will become apparent on reading the following detailed description and examining the appended drawings, in which:

FIG. 1 is a diagrammatic perspective view of a hinge in accordance with a first embodiment of the disclosure herein installed in an electrical cabinet of an aircraft and surrounding a cable, with a door of the electrical cabinet open as far as possible.

FIG. 2 is a diagrammatic perspective view of a mobile part of the hinge from FIG. 1.

FIG. 3 is a diagrammatic perspective view of an immobile part of the hinge from FIG. 1.

FIG. 4 is a diagrammatic perspective view of the mobile part from FIG. 2 and the immobile part from FIG. 3 in a position with the two parts brought close together in order to assemble them together.

FIG. 5 is a diagrammatic perspective view of the hinge from FIG. 1 in a position for insertion or extraction of an electrical cable.

FIG. 6 is another diagrammatic perspective view of the hinge from FIG. 1 in the position with the door open as far as possible.

FIG. 7 is a diagrammatic perspective view of the hinge from FIG. 1 in a closed position of the door.

FIGS. 8A-8D show diagrammatic side views of the hinge from FIG. 1, respectively corresponding to positions of assembly, cable insertion, maximum door opening and door closing.

FIGS. 9A-9D are diagrammatic perspective views of the hinge from FIG. 1, corresponding to the positions already indicated with reference to FIGS. 8A-8D.

FIGS. 10A-10D show diagrammatic views in section on the plane X-X of steps 9A to 9D.

FIG. 11 is a diagrammatic view in section on the plane XI-XI of FIG. 8D.

FIG. 12 is a diagrammatic partial perspective view of another embodiment of the hinge from FIG. 1.

FIGS. 13A-13D show diagrammatic views in section of the hinge from FIG. 12, steps 13A to 13D respectively corresponding to positions of assembly, cable insertion, maximum door opening and door closing.

FIGS. 14A-14D are diagrammatic perspective views of the hinge from FIG. 12, steps 14A to 14D corresponding to the positions already indicated with reference to FIG. 13A-13D.

FIG. 15 is a diagrammatic view in section of the hinge from FIG. 14D.

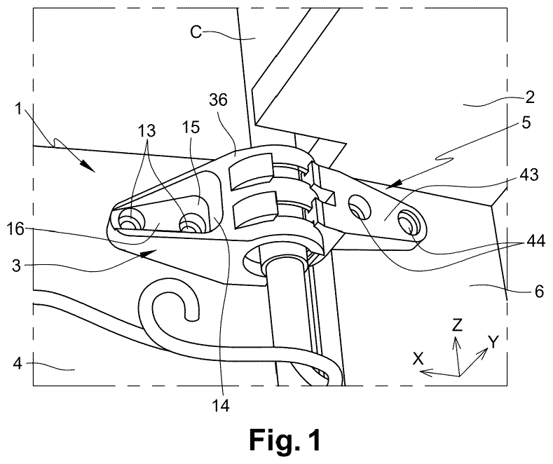

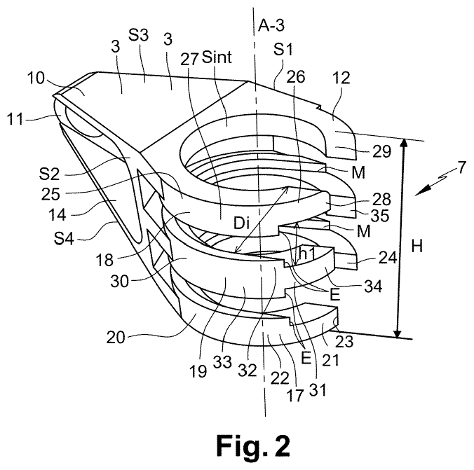

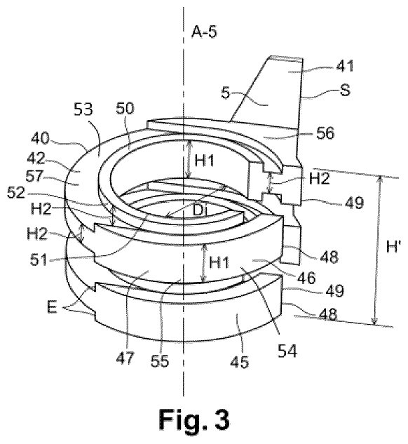

### DETAILED DESCRIPTION

The examples and the associated conditions described in detail here are mainly intended to assist the reader in understanding the principles of the disclosure herein and not to limit its scope to these specific examples and conditions. It will be clear that the person skilled in the art is in a position to design various arrangements which, although not explicitly described or represented here, nevertheless embody the principles of the disclosure herein and are included in its spirit and its scope.

Furthermore, to facilitate this understanding the following description may describe somewhat simplified embodiments of the disclosure herein. As the person skilled in the art understands, other embodiments of the disclosure herein can be of greater complexity.

In some cases examples of modifications of the disclosure herein may also be described. This is done simply as an aid to understanding, and once again not to define the scope of or to establish the limits of the disclosure herein. These modifications do not constitute an exhaustive list and the person skilled in the art could make other modifications while remaining within the framework of the disclosure herein.

Furthermore, all statements hereinafter relating to principles, aspects and embodiments of the disclosure herein and specific examples thereof are aimed at encompassing both structural and functional equivalents thereof, whether known at present or developed in the future.

As can be seen in the figures, the disclosure herein has as an object a hinge 1 intended to equip a door of a fixture 2, for example an electrical cabinet of an aircraft, or a hatch of the aircraft.

The hinge 1 comprises a first part 3, called the mobile part, intended to be mounted on a door 4 of the fixture 2 and a second part 5, called the immobile part, intended to be mounted on a box 6 of the fixture 2.

To simplify reading of the present description an orthonormal frame of reference (X, Y, Z) is depicted in the figures. The direction Z corresponds to a pivot axis of the door 6 preferably but not limitingly chosen to be vertical. The directions X and Y are orthogonal to the direction Z, the direction X being within the plane of the door.

The mobile part 3 and the immobile part 5 each include at least one hinge part. Preferably but not limitingly one of the mobile part 3 and the immobile part 5 includes one more hinge part than the other of the immobile part 5 and the mobile part 3. In other words, in one embodiment the mobile part 3 includes N hinge parts and the immobile part 5 includes N+1 hinge parts. In another embodiment the immobile part 5 includes N hinge parts and the mobile part 3 includes N+1 hinge parts. In the embodiments depicted here, the mobile part 3 includes three hinge parts and the immobile part 5 includes two hinge parts.

The hinge parts of the mobile part 3 and the hinge parts of the immobile part 5 are shaped to cooperate with one another, the hinge parts of the mobile part 3 moving between two hinge parts of the mobile part 5 so that an electrical cable C can be inserted in the hinge 1 and retained in position in the direction Z, as described in detail later.

The mobile part 3 is described in detail next.

As can be seen in the figures the mobile part 3 includes a body 10, for example a molded plastic body, extending between a first end 11 and a second end 12.

The body 10 widens from the first end 11, which is thin and curved, to the end 12, which is wider. Between the ends 11, 12 the body 10 is defined by opposite pairs of external surfaces S1, S2, S3 and S4 each extending between the first end 11 and the second end 12.

The surface S1 is substantially plane and pierced by two orifices 13. The surface S1 is designed to be pressed against the door 4. The surfaces S3 and S4 have a trapezoidal general shape.

The body 10 includes a cavity 14 consisting of a recess on the external surface S2 and a bottom 15 of which constitutes a plate 16 for fixing the mobile part 3 to the door 4. The plate 16 includes two orifices 13 for receiving screws for fastening the hinge 1 to the door 4.

The end 12 carries the hinge parts 7 of the mobile part 3. In the embodiments depicted here and in a non-limiting manner the mobile part includes three hinge parts 17, 18 and 19, respectively called the lower hinge part, the upper hinge part and the intermediate hinge part.

The hinge parts 17, 18 and 19 have the general shape of a hollow and open-sided cylinder, as described in detail later. The cylinders of the hinge parts 17, 18, 19 are coaxial with an axis A-3 parallel to the direction Z. The cable C can therefore be inserted in the hinge parts and retained in the hinge 1 along the axis Z.

As already indicated the lower hinge part 17 is a tongue in the general shape of a hollow and open-sided cylinder and is defined by a plane exterior wall 20. The lower hinge part 17 includes a first part 21 called the base part surmounted in the direction Z by a second part 22 called the internal part. The first part 21 extends between a first end 23 and a facing second end 24 of the tongue defining an opening angle α of the tongue 17 for example of between 20° and 45°.

The internal part 22 has an opening angle greater than that of the base part 21, which defines a shoulder E in the exterior wall 20 in the direction Z. In a plane (X, Y) the thickness of the base part 21 is greater than that of the internal part 22, which defines a step M between the base part 21 and the internal part 22. The step M is joined to the shoulder E along a rectilinear edge.

In other words, the lower hinge part 17 includes two coaxial C-shaped blocks one on top of the other formed by the base part 21 and the internal part 22, the C shape of the internal part 22 being smaller than, that is to say thinner and with a wider opening than, the C shape of the base part 21.

The upper hinge part 18 is symmetrical to the lower hinge part relative to a plane (X,Y).

As already indicated the upper hinge part 18 is a tongue with the general shape of a hollow and open-sided cylinder and is defined by a plane exterior wall 25. The upper hinge part 18 comprises a first part 26 called the base part below which in the direction Z is located a second part 27 called the internal part. The base part 26 extends between a first end 28 and a facing second end 29 of the tongue defining a given opening angle between 20° and 45° for example. In the embodiments depicted here the opening angle α of the base part 26 is the same as that of the base part 21 of the lower tongue 17.

The internal part 27 has an opening angle greater than that of the base part 26, which defines a shoulder E in the exterior wall 25 in the direction Z. In a plane (X, Y) the thickness of the base part 26 is greater than that of the internal part 27, which defines a step M between the base part 26 and the internal part 27. The step M is joined to the shoulder E along a rectilinear edge.

In other words the upper hinge part 18 includes two C shapes, one on top of the other, formed by the base part 26 and the internal part 27, the C shape of the internal part 27 being smaller than, that is to say thinner and having a wider opening than, the C shape of the base part 26.

As already indicated the intermediate hinge part 19 is a tongue with the general shape of a hollow and open-sided cylinder and is defined by a plane exterior wall 30. The intermediate hinge part 19 comprises a part called the base part 31 surmounted on either side in the direction Z by a part 32 called the upper part and a part 33 called the lower part that are symmetrical to one another in a plane (X,Y).

The base part 31 extends between a first end 34 and a facing second end 35 of the tongue defining a given opening angle between 20° and 45° for example. In the embodiments depicted here the opening angle α of the base part 31 is the same as that of the base part 21 of the lower tongue 17 and that of the base part 26 of the upper tongue 18.

The upper part 32 and the lower part 33 have an opening angle greater than that of the base part 31, which defines two shoulders E in the exterior wall 30 in the direction Z. In a plane (X, Y) the thickness of the base part 31 is greater than that of each of the upper part 32 and the lower part 33, which defines two steps M, one between the base part 31 and the upper part 32 and one between the base part 31 and the upper part 33.

As can be seen in the figures the same distance separates the lower hinge part 17 from the intermediate hinge part 18 and the intermediate hinge part 18 from the upper hinge part 19. The distance in the direction Z between the ends 23 and 34, 24 and 35, 34 and 28, and 35 and 29, respectively, is denoted h1.

As can be seen in the figures the base parts 21, 26 and 31 have the same height in the direction Z and Sint denotes the surface of each of the base parts 21, 26 and 31 defining the hinge parts of the mobile part 3 on the side of the hollow internal space.

As can be seen in the figures the base parts 21, 26 and 31 of the mobile part 3 have the same inside diameter di. H denotes the distance between the facing lower and upper ends, namely 23 and 28, and 24 and 29.

As can be seen in the figures the body 10 includes a junction portion 36 with a face in the shape of an E, each branch of which connects the part carrying the plate 16 to one of the tongues 17 to 19.

The opening angle α defines the angular opening of the mobile part 3. The internal volume of height H defined by the hollow space between the hinge parts 17 to 19 is the internal volume of the mobile part 3.

The immobile part 5 is described in detail next.

As can be seen in the figures the immobile part 5 includes a body 40, for example a molded plastic body, comprising a first part 41 and a second part 42.

The first part 41 includes a plate portion 43 for fixing the immobile part 5 to the box 6. The plate 43 includes two orifices 44 for screws to pass through. An external surface S of the immobile part 5 carrying the plate 43 is flat so that the immobile part 5 can be pressed against the box 4.

The second part 42 carries the hinge parts 7 of the immobile part 5. In the embodiments depicted here the immobile part non-limitingly includes two hinge parts 45, 46 respectively called the upper hinge part and the lower hinge part.

The hinge parts 45 and 46 have the general shape of a hollow and open-sided cylinder as described in detail later. The cylinders of the hinge parts 45, 46 are coaxial and have an axis A-5 parallel to the direction Z. The cable C can therefore be inserted in the hinge parts and retained in the hinge 1 along the axis Z.

As already indicated the upper hinge part 46 is a tongue with the general shape of a hollow open-sided cylinder and is defined by a plane exterior wall 47. The wall 47 extends between a first end 48 and a facing second end 49 defining an opening angle of the immobile part 5. The opening angle β is for example between 20° and 45°. In the embodiments depicted here the opening angle of the upper hinge part 45 is the same as that of the lower hinge part 45.

Starting from the centre of the cylinder, the upper hinge part 46 includes a first open-sided cylinder 50 with a height H1 in the direction Z defined between an external wall 51 and an internal wall 52 opposite the external wall 51.

The upper hinge part 46 includes a second open-sided cylinder 53 coaxial with the first cylinder 50. The second cylinder 53 extends between an internal wall coinciding with the internal wall 52 of the first cylinder 50 over a height H2 strictly less than the height H1 and an external wall 54 the height of which is not constant. The external wall 54 corresponds to the exterior wall 47 of the hinge part 46.

In two end parts 55, 56 defined between each end of the tongue 48, 49 and a central part 57 the height of the second cylinder 53 is that of the first cylinder 50, that is to say H1, and in the central part 57 the height of the second cylinder 53 is equal to H2. As can be seen in the figures the hinge part 46 has an H-shaped section.

In other words each of two shoulders E defines end parts 55, 56. The thickness of the end parts 55, 56 is strictly less than the thickness of the central part.

An inside diameter of the hinge part 46 is denoted Di. The distance between the facing lower and upper ends, namely 23 and 28, and 24 and 29, is denoted H′.

The lower hinge part 45 is identical to the upper hinge part 46. Also, to simplify the description the same reference numbers 47 to 57 apply to the lower hinge part 45.

The opening angle β defines the angular opening of the immobile part 5. The opening angle β of the immobile part 5 is preferably equal to the opening angle α of the mobile part 3.

The internal volume of height H′ defined by the hollow space between the hinge parts 45 and 46 is the internal volume of the immobile part 5.

The hinge parts 17 to 19 of the mobile part 3 and the hinge parts 45, 46 of the immobile part 5 are sized for optimum functioning of the hinge 1.

The height H1 of the first and second cylinders 51, 53 of the hinge parts 45, 46 of the immobile part 5 is equal to the distance h1 between the ends of the lower hinge part 17 and the intermediate hinge part 19 and between the ends of the intermediate hinge part 19 and the upper hinge part 18 of the mobile part 3.

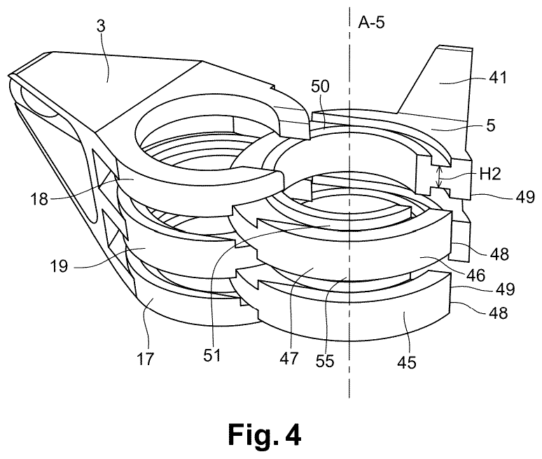

The diameter di of the base parts 21, 26 and 31 of the mobile part 3 is equal to the diameter Di of the hinge parts 45, 46 of the immobile part 5. As can be seen in FIG. 4 an external surface of the hinge 1 is therefore plane in the position for insertion and extraction of the cable.

The step M of the two C shapes of each hinge part 17, 18, 19 of the mobile part 3 is equal to the difference between the heights H1 and H2. Accordingly, to assemble the mobile part 3 onto the immobile part 5 the part of the first cylinder 50 of each of the hinge parts 45, 46 that projects from the second cylinder 53 on either side of the second cylinder 53 having a height H1-H2 can be locked against the steps M of the hinge parts 17 to 19. Accordingly, during rotation of the mobile part 3 relative to the immobile part 5 during use of the door the hinge parts 17 to 19 of the mobile part are guided in movement in the hinge parts 45, 46 of the immobile part.

Assembling the hinge 1 is described next.

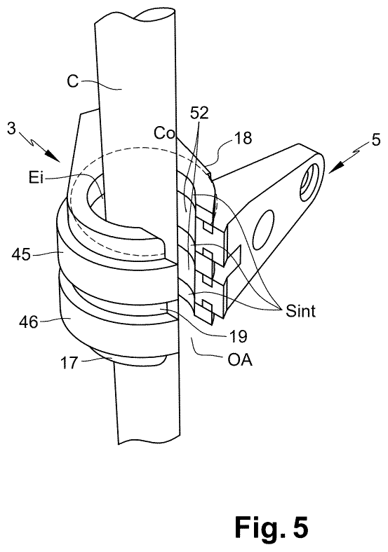

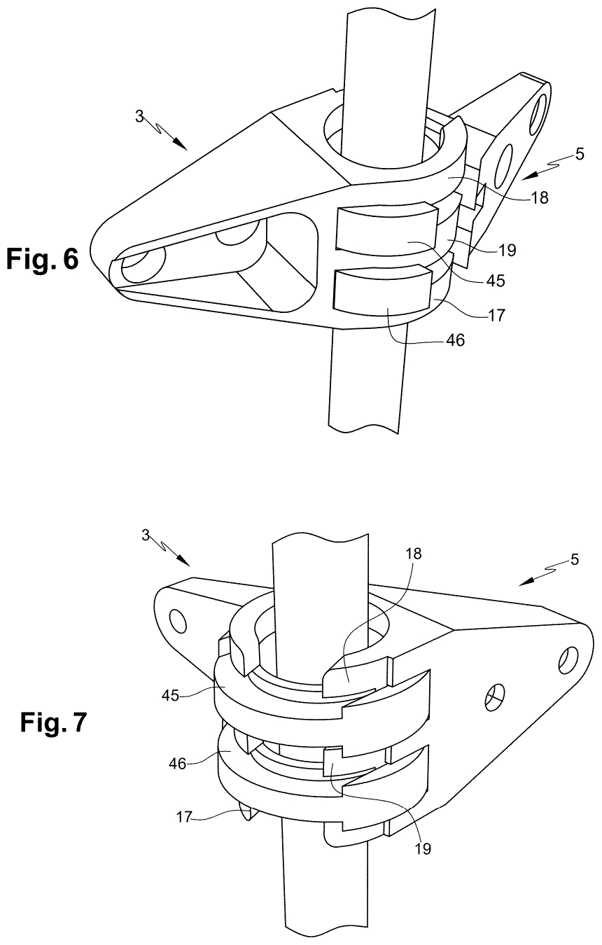

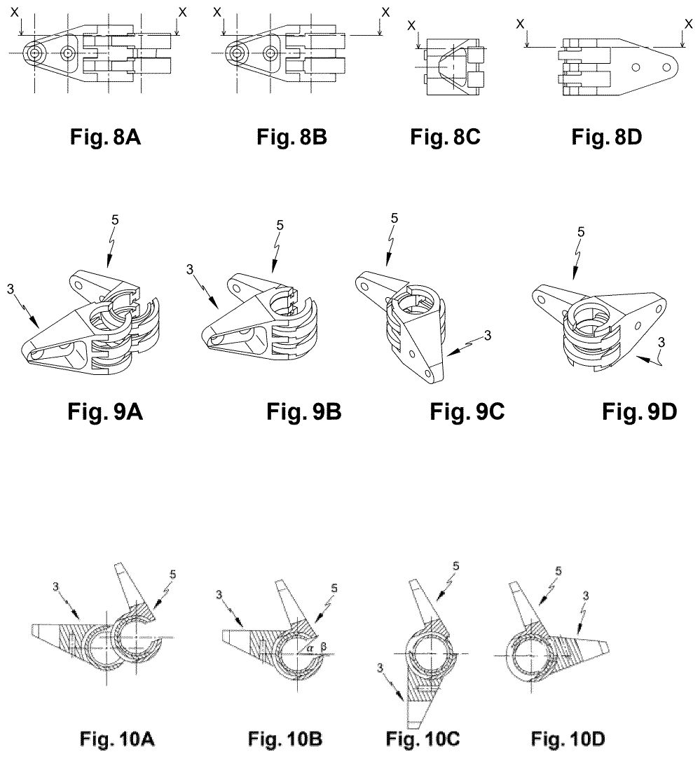

In a first step (FIGS. 8A, 9A and 10A) the mobile part 3 and the immobile part 5 are offered up face-to-face after which the hinge part 46 of the immobile part 5 is inserted between the upper hinge part 19 and the intermediate hinge part 18 of the mobile part 3 and the hinge part 45 of the immobile part 5 is inserted between the intermediate hinge part 18 and the lower hinge part 17 of the mobile part 3 until the hinge parts 17 to 19 of the mobile part 3 are immobilized by abutting against the hinge parts 45, 46 of the immobile part 5 (FIGS. 5 8B, 9B, and 10B). The axes A-3 and A-5 then coincide and the hinge parts 17 to 19 and 45, 46 are coaxial.

In this position the openings of each of the hinge parts 17 to 19 of the mobile part 3 are aligned with the openings of the hinge parts 45 and 46 of the immobile part 5, which opens up a contour Co of the hinge 1 and allows insertion or extraction of the cable C. This position defines the open position of the hinge 1. In this position the ends 23, 34, 28, 24 and 48 on the one hand and the ends 35, 34 and 29, 35, 29 and 49 on the other hand are aligned.

The alignment of the openings of the hinge parts of the mobile part 3 and the immobile part 5 defines an angular opening OA of the hinge 1 of angle α. A hollow volume defined by the surfaces Sint of the mobile part 3 and the internal walls 52 of the immobile part 5 defines the internal space Ei of the hinge 1.

Note that in the hinge 1 the cable C extends along the axis A-3, A-5 of the hinge 1.

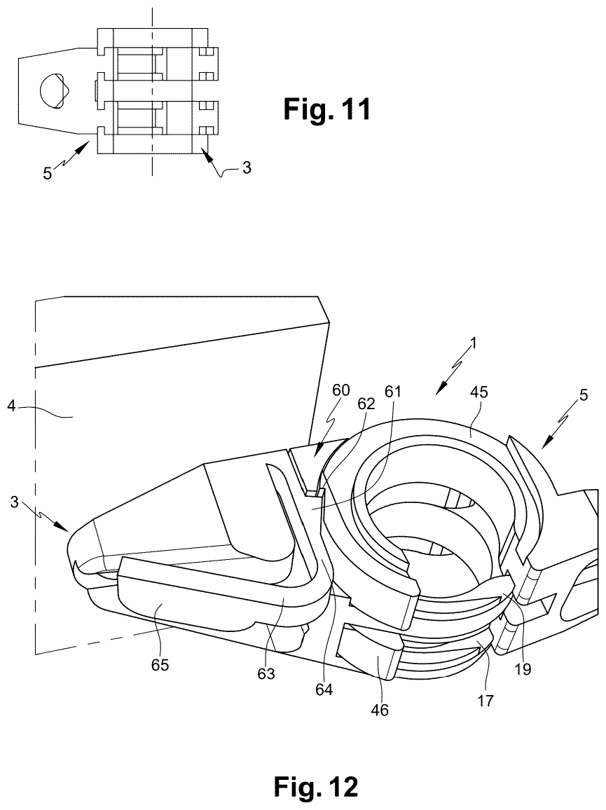

The hinge 1 having been installed on the fixture, the mobile part 3 then pivots between two end positions, namely a closed position of the door (FIGS. 8D, 9D, 10D and 11) and an open, so-called maximum open, position of the door (FIGS. 8C, 9C and 10C), corresponding to an authorized maximum rotation angle of 110° for example.

Between and in these two end positions the contour Co of the hinge 1 is closed only by the hinge parts 17 to 19 of the mobile part 3 or by the hinge parts 45, 46 of the immobile part 5 or by the alignment of the hinge parts 17 to 19, 45, 46 of the mobile part 3 and the immobile part 5. The cable C is therefore retained in the hinge 1 in the closed positions of the hinge.

All these positions correspond to closed positions of the hinge 1.

In the embodiments depicted here and in the maximum open position (FIGS. 8C, 9C and 10C) the angular openings of the immobile part 5 and of the mobile part 3 are blocked by the ends of the hinge parts 17 to 19 of the mobile part 3 adjoining the ends of the hinge parts 45, 46 of the immobile part 5, which closes the contour Co.

In the closed position the angular openings of the immobile part 5 and 3 are respectively blocked by central parts of the hinge parts of the opposite part 3, 5, which closes the contour Co.

The travel of the hinge parts 17 to 19 of the mobile part 3 is as follows. To go from the open position of the hinge 1 to the closed position of the hinge with the door open to the maximum the hinge parts 17 to 19 turn in a plane (X, Y) by a sufficient angle (a quarter-turn anticlockwise in the embodiments depicted here) for the ends of the hinge parts 17 to 19 to adjoin the ends of the hinge parts 45, 46. Then, to close the door, the hinge still being in the closed position, the hinge parts 17 to 19 pivot, still in the same direction (by a quarter-turn in the embodiment depicted here). In other words, the travel and the dimensions of the mobile part 3 are such that the hinge parts 17 to 19 are moved in such a manner as always to block the angular opening of the hinge parts 45, 46 of the immobile part 5 in this position of the hinge 1.

Note that the disclosure herein is of course not limited to this anticlockwise rotation direction or to a quarter-turn.

In another embodiment the hinge 1 includes a device 60 for locking the hinge in the closed position.

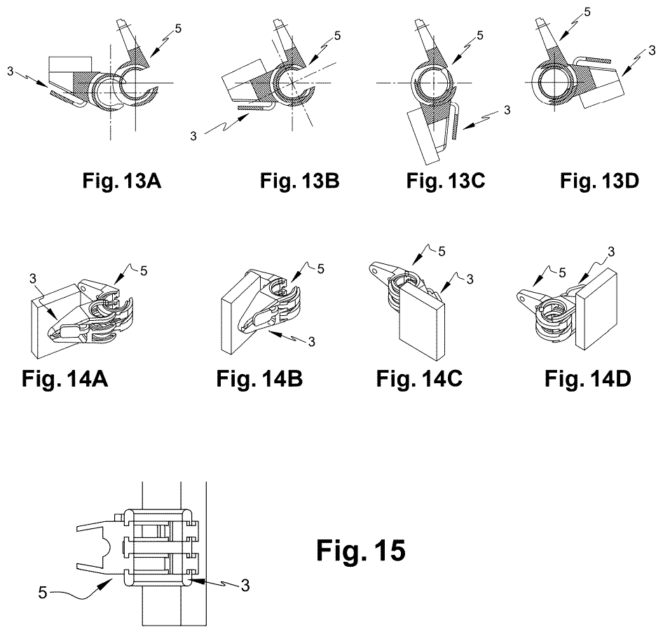

In FIGS. 12 to 15 the locking device 60 includes a lug 61 and a bearing surface 62 for the lug 61 on one of the hinge parts 45, 46. The bearing surface is a recessed shoulder in the cylinder 53 of the upper hinge part 46.

The locking device 60 includes an actuator 63 for actuating the lug 61. In FIGS. 12 to 15 the actuator 63 includes a flexible arm 64 fastened to the lug 61 and that can be activated by a button 65.

When the door is used the hinge part 45, 46 of the mobile part is able to pivot between the maximum open position of the door and the closed position of the door but its travel is blocked beyond this by the lug 61 abutting against the bearing surface 62, which locks the hinge 1 in the closed position.

When it is wished to open the hinge 1 to insert or to extract the cable C the button 65 is activated, which pulls the lug 61 away from the bearing surface 62 and allows the hinge parts 45, 46 to move to the open position of the hinge 1.

In other words, the travel of the hinge parts increases until the open position of the hinge 1 is reached.

In a variant that is not depicted the actuator 63 is made secure, for example by an imprint to receive an accessory such as a screwdriver.

Apart from the presence of the locking device 60 the hinge 1 in accordance with the second embodiment is identical to the hinge 1 in accordance with the first embodiment.

The hinge 1 in accordance with the embodiments of the disclosure herein can be fitted or removed without it being necessary to cut the cable inserted in the hinge. To the contrary, it suffices to extract the cable before removing the hinge 1. The hinge 1 in accordance with the embodiments of the disclosure herein also enables modification of the wiring of the aircraft without dismantling the hinge since it suffices to open the hinge 1, replace the cable and close the hinge 1 again.

Note that the hinge 1 does not have a physical hinge pin. The action of the hinge 1 is the result of aligning the hinge parts 17 to 19 of the mobile part 3 and the hinge parts 45, 46 of the immobile part 5.

Modifications and improvements to the embodiments of the disclosure herein described hereinabove will be apparent to the person skilled in the art. In particular, the embodiments and variants described hereinabove can be combined with one another provided that they are not incompatible. The above description by examples is illustrative rather than limiting. The scope of the disclosure herein is therefore limited only by the scope of the following claims.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A hinge to open or to close a door or a door of an electrical cabinet of an aircraft, including at least one first wall and one second wall defining an angular opening of the hinge and a hollow internal space of the hinge sized to receive a cable, the first wall and the second wall being positioned relative to one another in order:
to open the hinge in a cable insertion or extraction position to allow the cable to pass through the angular opening of the hinge inside or outside the internal space; and
to close the hinge in working positions of the hinge between a maximum open position of the door and a closed position of the door to block the angular opening of the hinge so as to be able to enclose the cable in the hollow space.

2. The hinge according to claim 1, wherein each first wall and each second wall respectively extends between two ends spaced apart from one another to form an angular opening and defines a hollow internal space, the hinge being shaped so that:
in the cable insertion or extraction position the angular opening of the first wall and the angular opening of the second wall are aligned; and
in the working positions of the door the angular opening of the first wall is offset from the angular opening of the second wall to close the hinge,
the first and second walls being aligned so as to define an axis of the hinge.

3. The hinge according to claim 2, including a mobile part to be fixed to the door of the cabinet and an immobile part to be fixed to a box of the cabinet, the mobile part including at least one hinge part forming the first wall of the hinge and the immobile part including at least one hinge part forming the second wall of the hinge, wherein action of the hinge is a result of alignment of the hinge parts of the mobile and immobile parts.

4. The hinge according to claim 3, wherein one of the mobile part and the immobile part includes one more hinge part than another of the mobile part and the immobile part.

5. The hinge according to claim 4, wherein one of the mobile part and the immobile part includes at least two hinge parts spaced apart from one another so as to guide at least one hinge part of another of the mobile part and the immobile part.

6. The hinge according to claim 1, including a locking device conformed to immobilize the hinge in the closed position.

7. An electrical cabinet including the hinge according to claim 1.

8. An aircraft including the electrical cabinet according to claim 7.

9. An aircraft hatch including the hinge according to claim 1.
